(19) United States
(12) Patent Application Publication
(10) Pub. No.: US 2009/0224186 A1
(43) Pub. Date: Sep. 10, 2009

(54) DUAL OPTO-COUPLER OPTICAL ISOLATION CIRCUIT

(76) Inventor: Mohamad A. Khalil, Bloomfield Hills, MI (US)

Correspondence Address: Masco Corporation, 21001 Van Born Road, Taylor, MI, 48480, US

(21) Appl. No.: 12/398,221

(22) Filed: Mar. 5, 2009

Related U.S. Application Data
(60) Provisional application No. 61/033,923, filed on Mar. 5, 2008.

(51) Int. Cl. G02B 27/00; H05B 41/36

(52) U.S. Cl. 250/551; 315/291

(57) ABSTRACT

An electrical control circuit detects a sensed value on a load and outputs an analog sensor signal. The analog sensor signal is passed through a plurality of isolation couplers which isolate a controller from a load. The plurality of isolation couplers are arranged such that the scaling factor of the first isolation coupler will cancel the scaling factor of the second isolation coupler.

The application claims priority to U.S. Provisional Application No. 61/033,923 which was filed on Mar. 5, 2008.

### BACKGROUND OF THE INVENTION

The present application is directed toward an isolator circuit for isolating a high voltage circuit from a low voltage control circuit.

Frequently in industrial applications, a high voltage or high current system must be monitored to ensure that the electrical power properties of the system meet select criteria, such as remaining within a voltage range, or remaining within a current range. Such systems frequently have power variations and fluctuations, such as transients, which can potentially damage sensor equipment and controllers.

One solution to problems caused by transients, which is recognized in industry, is gap isolation of the controller via opto-couplers, inductance couplers, capacitor couplers, or other gap isolation circuits. By way of example, an opto-coupler provides a circuit which converts an electrical signal to an optical signal, and reconverts the signal back to an electrical signal. The optical connection isolates the load from the controller for reasons such as safety, while still allowing the signal to be transmitted. Other gap isolators operate similarly with a different type of signal being transmitted across the gap. (IE an inductance coupler will convert the signal to inductance and then back into an analog electrical signal instead of using optical signal.) While such an arrangement addresses the potential problems caused by a high voltage load in direct connection with a controller, it can give rise to new problems due to a scaling factor present in all gap isolators.

The scaling factor of an opto-coupler is the factor by which the analog signal is modified, and results from the conversion from an electrical signal to an optical signal and the reconversion from an optical signal to an electrical signal. The scaling factor in opto-couplers, as well as in other gap isolators, can vary significantly between batches due to variations in the manufacturing process, even from the same manufacturing line.

As a result of the scaling factor, the output of the opto-coupler is scaled to a different magnitude than the input, while still retaining the signal characteristics of the input signal. Currently, in order to compensate for the signal scaling effect described above, each individual device must be calibrated to determine the magnitude of the scaling, and a compensating circuit must then be used to achieve the desired measurement accuracy. Individual calibration requires a significant time investment as well as raises costs associated with production. Similar problems arise when other forms of gap isolators such as capacitor isolators, inductance isolators, etc. are used.

### SUMMARY OF THE INVENTION

Disclosed is an electrical control circuit. The control circuit has a sensor on a load and at least a first and a second gap isolator. The sensor detects the electrical properties of the load. The sensor signal is passed through the first gap isolator, which has a certain scaling factor. The signal is then sent through a second gap isolator which provides a scaling factor which is nearly the same scaling factor as in the first gap isolator and outputs an analog signal representing the sensor signal to a controller.

These and other features of the present invention can be best understood from the following specification and drawings, the following of which is a brief description.

### BRIEF DESCRIPTION OF THE DRAWINGS

FIG. 1 illustrates a schematic diagram of an embodiment of the gap isolation circuit.

FIG. 2a illustrates a first opto-coupler schematic such as would be used the embodiment of FIG. 1.

FIG. 2b illustrates a second opto-coupler schematic such as would be used in the embodiment of FIG. 1.

### DETAILED DESCRIPTION OF THE PREFERRED EMBODIMENT

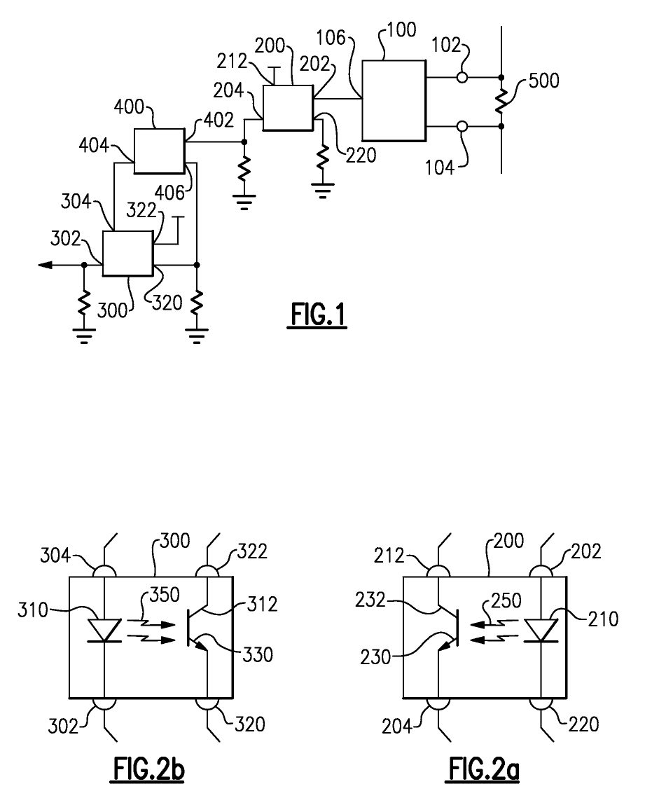

Utilizing a gap isolator for isolating a control circuit from a high voltage source results in signal scaling where the magnitude of the signal is altered and other signal characteristics are retained. When it is desirable to detect a power characteristic which would be altered by the gap isolator scaling, such as current magnitude, it is necessary to devise a way to compensate for the variability in scaling factors. One method which can be used to compensate for scaling variability is to utilize a first and a second gap isolator with similar scaling factors and combine them to cancel out the effect of the scaling factor. An example of the above described circuit using opto-couplers is illustrated in FIG. 1.

In the example of FIG. 1 an optical isolation circuit has a current sensor 100, a first opto-coupler 200, a second opto-coupler 300, and an operational amplifier (op-amp) 400. The current sensor 100 can be, alternately, any sensor with which it would be desirable to isolate the load being sensed from the control circuit, such as a high voltage circuit and a low voltage user interface control circuit.

The current sensor 100 is connected to an input 202 of the first opto-coupler 200. The first opto-coupler 200 has an output 204 which connects to an op-amp 400 at an input 402. The op-amp 400 has an output 404 which is connected to an input (anode) 304 of a photo-diode (pictured in FIG. 2) of the second opto-coupler 300. The op-amp 400 additionally has an input 406 connected to the emitter of a photo-transistor of the second opto-coupler 300 (pictured in FIG. 2). The second opto-coupler 300 additionally has a cathode 302 where an analog signal, which has been scaled in the first opto-coupler 200 and replicated in the second opto-coupler 300, is sensed.

The sensor 100 has two connections 102, 104 to a load 500. The sensor 100 detects electrical properties of the load 500, such as current, frequency, voltage, etc., and outputs an analog signal at a sensor output 106. The analog signal represents the load 500 characteristic(s) being measured by the sensor 100 and additionally reflects any transients or other power fluctuations which occur in the load 500.

The analog output 106 is connected to an opto-coupler 200 which accepts the analog signal at an input (anode) 202, converts the signal to an optical signal, transmits the optical signal across an air gap, and then reconverts the signal into an analog electrical signal which is output at the opto-coupler output (emitter) 204.

The opto-coupler output 204 of the first opto-coupler 200 is connected to an op-amp 400 input 402. The op-amp 400 then conditions the signal, to force the voltage of the transistor emitter (pictured in FIG. 2) of the first opto-coupler 200 to be the same as the voltage of the transistor emitter of the second opto-coupler 300. Methods and circuits for performing this conditioning using an op-amp are known in the art.

Once the conditioning has been performed, the signal is input into the second opto-coupler 300 at input (anode) 304. The second opto-coupler 300 is connected such that the second opto-coupler 300 scales the signal the same as the first opto-coupler 200 scaling. By way of example if both of the opto-couplers 200, 300 had a scaling factor of X, the first opto-coupler 200 would multiply the signal magnitude by X, and the second opto-coupler 300 would multiply the signal magnitude by X, resulting in a signal at the cathode 302 of the second opto coupler which accurately represents the sensed input to opto-coupler 100, while not retaining modifications to the original signal input 202 caused by a single opto-coupler isolator. The scaling factor can be any value, such as a function f(n). As a result of the first scaling factor and the second scaling factor being the same or nearly the same, the final system output of the dual opto-coupler system, as measured at 302, is an analog signal which accurately represents the desired characteristic of the load being monitored.

In order to achieve proper replication in the above circuit it is necessary for both of the opto-couplers 200, 300 to have similar scaling values. The amount of variance between the scaling values which is allowable depends on the particular application, with a greater need for sensor precision requiring a lesser variance between the opto-coupler scaling values. One way to solve this problem is to utilize opto-couplers from the same batch. In this way, any impurities, or deviations in the manufacturing process which are present in one of the opto-couplers will additionally be present in the other. Another way would be to calibrate each opto-coupler and pair it with a second opto-coupler with a scaling value within the desired tolerance. Additionally, the opto-couplers can be created as independent components or as part of a circuit on one integrated circuit package which would help ensure similar scaling factors for each opto-coupler for the same reasons as using opto-couplers from a single batch.

Example opto-couplers 200, 300, which can be used in the example of FIG. 1, are shown in FIGS. 2a and 2b. The opto-coupler 200 illustrated in FIG. 2a utilizes a photo-diode 210 and a photo-transistor 232. The sensor signal enters the opto-coupler 200 at the photo-diode 210 through an input 202. The photo diode 210 emits an optical signal across the light gap 250, which is received by the photo-transistor 232. The photo-signal switches the photo-transistor 232 on, which allows current flow from a collector 212 to an opto-coupler emitter 230. In the example of FIGS. 1 and 2a the opto-coupler emitter 230 is connected to the opto-coupler output 204. The opto-coupler 200 additionally connects the photo-diode 210 to ground through an output 220, and connects the photo-transistor 232 to a voltage source through collector 212. FIG. 2b illustrates a schematic of the second opto-coupler 300. In order to replicate the scaling of the opto-coupler, as described above, the connections are made in a different manner, such that the cathode 302 of the photo-diode 310 will accurately represent the analog signal input from the sensor into the dual opto-coupler at input 202. In the schematic illustrated in FIG. 2b, the collector input 322 for the photo-transistor 312 is again connected to a voltage source. The opto-coupler emitter 330 is, however, connected to an input of the op-amp 400. The output 404 (pictured in FIG. 1) of the op amp 400 is connected to an input (anode) 304 of the photo-diode 310. This configuration places the second opto-coupler 300 in a feedback path of the op amp 400.

Placing the second opto-coupler in the feedback path allows the current flowing through the photo-transistor to be the same. Since the second opto-coupler 300 has the same or nearly the same scaling factor as the first opto-coupler, the op-amp forces the two inputs of the first and second opto-coupler to have the same voltage level. Therefore, the current that flows through the photo-transistor of the first opto-coupler is the same as the current that flows through the photo-transistor of the second opto-coupler, and the input current on the high voltage side is duplicated on the low voltage side.

It is known that any other circuit configuration whereby the first opto-coupler 200 and the second opto-coupler 300 have the same scaling factor will function as described above, and will meet the elements of the present application. It is additionally known that a similar circuit can be constructed using any other type of gap isolators, instead of opto-couplers, and still fall within the above disclosure.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An electrical control circuit comprising;
a sensor capable of sensing a load characteristic;
a first gap isolator connected to said sensor and an amplifier;
said amplifier being capable of processing an output of said first gap isolator and connected to a second gap isolator; and
said second gap isolator connected to an analog output, whereby said sensor, said first gap isolator, said amplifier, and said second gap isolator cooperate to output a signal representing an analog current sensed by said current sensor.

2. The electrical control circuit of claim 1, wherein said first gap isolator comprises an opto-coupler, and said second gap isolator comprises an opto-coupler.

3. The electrical control circuit of claim 2, wherein said first opto-coupler has a scaling factor whereby the output is scaled, said second opto-coupler has a scaling factor whereby the second opto-coupler's output is scaled, and wherein said scaling factors are within a pre-defined tolerance of each other.

4. The electrical control circuit of claim 2, wherein said first opto-coupler comprises a photo-diode and a photo-transistor.

5. The electrical control circuit of claim 4, wherein said photo-diode is connected to said current sensor, and said photo-transistor is connected to said operational amplifier.

6. The electrical control circuit of claim 2, wherein said second opto-coupler comprises a photo-diode and a photo-transistor.

7. The electrical control circuit of claim 6, wherein said photo-diode is connected to an operational amplifier output, and said photo-diode is connected to an analog signal output.

8. The electrical control circuit of claim 6, wherein said photo-transistor comprises a collector and an emitter, and wherein said drain is connected to an operational amplifier input.

9. The electrical control circuit of claim 2, wherein said first opto-coupler and said second opto-coupler are from a single production batch.

10. The electrical control circuit of claim 2, wherein each of said first opto-coupler, said second opto-coupler, and said operational amplifier comprise a single chip.

11. The optical isolation circuit of claim 2, wherein each of said first opto-coupler and said second opto-coupler comprise a single chip.

12. An isolation circuit comprising;
a first gap isolator having a scaling factor; and
a second gap isolator having a scaling factor, wherein said second gap isolator is connected to the first gap isolator such that distortion resulting from a scaling factor of the gap isolators is minimized.

13. The isolation circuit of claim 12, wherein each of the first gap isolator and the second gap isolator comprise an opto-coupler.

14. The isolation circuit of claim 13, wherein each of said opto-couplers comprises a photo-diode and a photo-transistor.

15. The isolation circuit of claim 13, wherein each of said first opto-coupler and said second opto-coupler comprise a single chip.

16. The isolation circuit of claim 13, additionally comprising an operational amplifier connecting said first opto-coupler and said second opto-coupler.

17. The isolation circuit of claim 16, wherein said operational amplifier is configured to condition an output of said first opto-coupler and provide an input for said second opto-coupler.

18. A method for optically isolating a sensor signal from a controller comprising;
passing an output of said sensor signal through a first opto-coupler, whereby said sensor signal is scaled according to a first opto-coupler scaling factor; and
passing an output of said first opto-coupler through a second opto-coupler, whereby said sensor signal is scaled according to a second opto-coupler scaling factor.

19. The method of claim 18, wherein said second opto-coupler is connected to a circuit in such a way as to provide a scaling factor which is the same scaling factor as the first opto-coupler.

20. The method of claim 19, comprising the additional step of processing an output of said first sensor signal using an amplifier, prior to said step of passing an output of said first opto-coupler through a second opto-coupler.
